(19) United States
(12) Patent Application Publication
(10) Pub. No.: US 2005/0195588 A1
(43) Pub. Date: Sep. 8, 2005

(54) Optical member, backlight assembly and display device having the same

(76) Inventors: Sung-Yong Kang, Suwon-si (KR); Jong-Dae Park, Seoul (KR); Yong-Gwang Won, Yongin-si (KR); Woong-Jae Chang, Suwon-si (KR)

Correspondence Address: CANTOR COLBURN, LLP, 55 GRIFFIN ROAD SOUTH, BLOOMFIELD, CT, 06002, US

(21) Appl. No.: 11/074,143

(22) Filed: Mar. 7, 2005

(30) Foreign Application Priority Data
Mar. 8, 2004 (KR) 2004-15458

(51) Int. Cl. F21V 9/14; F21V 5/00

(52) U.S. Cl. 362/19; 362/582

(57) ABSTRACT

An optical member is disposed between a light generating section that generates light and a display section that displays images by using the light generated by the light generating section. The optical member includes a light polarizing part and a light diffusing part. The light polarizing part polarizes the light generated by the light generating section. The light diffusing part is integrally formed with the light polarizing part to diffuse the light to enhance uniformity of luminance of the light. Therefore, weight, volume, etc. of the optical member may be reduced.

### BACKGROUND OF THE INVENTION

1. Field of the Invention

The present invention relates to an optical member, a backlight assembly and a display device having the optical member. More particularly, the present invention relates to an optical member having reduced thickness and weight, a backlight assembly and a display device having the optical member.

2. Description of the Related Art

Display devices convert data processed by an information processing device into images. Liquid crystal display (LCD) devices display images by varying light transmittance of liquid crystal.

Generally, an LCD device includes an LCD panel and a backlight assembly. The backlight assembly provides the LCD panel with light. The LCD panel converts the light provided from the backlight assembly into images. Since luminance and uniformity of luminance of the backlight assembly have an influence on a display quality of the LCD panel, an optical member is often disposed between the LCD panel and the backlight assembly. The optical member enhances the luminance and the uniformity of luminance of light provided by the backlight assembly, and provides the LCD panel with light having enhanced luminance and uniformity of luminance to improve the display quality of the LCD panel.

However, the addition of the optical member increases a weight and thickness of the LCD device. Furthermore, the addition of the optical member increases a cost of manufacturing the LCD device. Thus, it is desired to provide an optical member capable of reducing the weight and thickness of the LCD device.

### SUMMARY OF THE INVENTION

The present invention provides an optical member capable of reducing the thickness and weight of an LCD device. The present invention also provides a backlight assembly having the optical member. The present invention also provides a display device having the backlight assembly.

In an exemplary optical member according to the present invention, the optical member is disposed between a light generating section that generates light and a display section that displays images by using the light generated by the light generating section. The optical member includes a light polarizing part and a light diffusing part. The light polarizing part is configured to polarize the light generated by the light generating section. The light diffusing part is integrally formed with the light polarizing part to diffuse the light to enhance uniformity of luminance of the light.

In an exemplary backlight assembly according to the present invention, the backlight assembly includes a plurality of lamps and a light polarizing part. The plurality of lamps generates light. The optical member is disposed over the plurality of lamps. The optical member includes a light polarizing part and a light diffusing part. The light polarizing part polarizes the light generated by the lamps. The light diffusing part is integrally formed with the light polarizing part to diffuse the light in order to enhance uniformity of luminance of the light.

In an exemplary display apparatus according to the present invention, the display apparatus includes a plurality of lamps, a display panel and an optical member. The plurality of lamps generates light. The display panel displays images by using the light generated by the plurality of lamps. The optical member is disposed between the plurality of lamps and the display panel. The optical member includes a light polarizing part and the light diffusing part. The light polarizing part is configured to polarize the light generated by the plurality of lamps. The light diffusing part is integrally formed with the light polarizing part to diffuse the light to enhance uniformity of luminance of the light.

Therefore, weight, volume, etc. of the display apparatus may be reduced. Furthermore, a cost of manufacturing the display device may be reduced.

This application relies for priority upon Korean Patent Application No. 2004-15458 filed on Mar. 8, 2003, the contents of which are herein incorporated by reference in its entirety.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a schematic diagram of a cross-sectional view illustrating an optical member according to a first exemplary embodiment of the present invention;

FIG. 2 is a schematic diagram of a cross-sectional view illustrating an optical member according to a second exemplary embodiment of the present invention;

FIG. 3 is a schematic diagram of a cross-sectional view illustrating an optical member according to a third exemplary embodiment of the present invention;

FIG. 4 is a schematic diagram of a cross-sectional view illustrating an optical member according to a fourth exemplary embodiment of the present invention;

FIG. 5 is a schematic diagram of a cross-sectional view illustrating an optical member according to a fifth exemplary embodiment of the present invention;

FIG. 6 is a perspective view illustrating an optical member according to a sixth exemplary embodiment of the present invention;

FIG. 7 is a schematic diagram of a cross-sectional view illustrating an optical member according to a seventh exemplary embodiment of the present invention;

FIG. 8 is an exploded perspective view illustrating a backlight assembly having the optical member of FIG. 7 according to an exemplary embodiment of the present invention;

FIG. 9 is a schematic diagram of a cross-section view illustrating a backlight assembly according to an exemplary embodiment of the present invention; and

FIG. 10 is an exploded perspective view illustrating a display device according to an exemplary embodiment of the present invention.

### DETAILED DESCRIPTION OF THE INVENTION

Hereinafter the embodiments of the present invention will be described in detail with reference to the accompanied drawings.

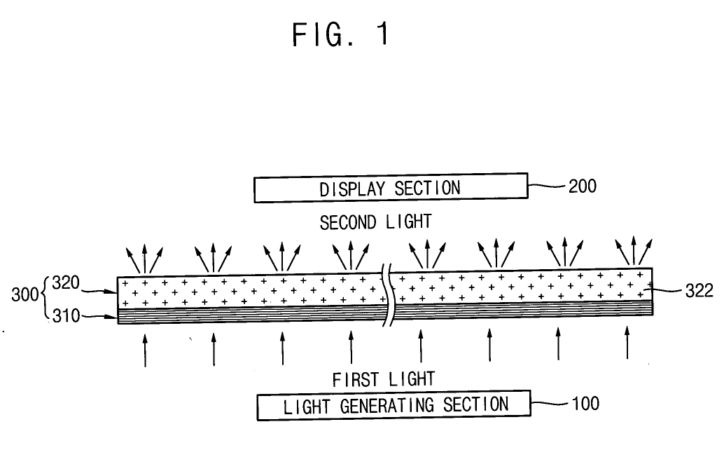

FIG. 1 is a schematic diagram of a cross-sectional view illustrating an optical member according to a first exemplary embodiment of the present invention.

Referring to FIG. 1, a light generating section 100 of a display device generates a first light. A luminance of the first light from the light generating section 100 is substantially same as that of light generated from a backlight assembly.

A display section 200 is disposed opposite to the light generating section 100 with respect to an optical member 300. In other words, the optical member 300 is disposed between the light generating section 100 and the display section 200. Light that passes through the optical member 300 is called a second light. The second light has a higher luminance and uniformity of luminance than the first light. The second light is used for displaying images at the display section 200. The optical member 300 disposed between the light generating section 100 and the display section 200 includes a light polarizing part 310 and a light diffusing part 320.

The light polarizing part 310 polarizes the first light. The light polarizing part 310 enhances luminance of the light passing through the optical member 300 thereby improving display quality of images displayed at the display section 200. The light polarizing part 310 is made of, for example, a film-like material. In particular, the light polarizing part 310 may employ a dual brightness enhance film (DBEF), which is a product manufactured by 3M Company. Although light that passes through the light polarizing part 310 has a high luminance, it has a low uniformity of luminance that may deteriorate display quality of images displayed at the display section 200. In order to enhance the uniformity of luminance of light exiting the optical member 300, the light diffusing part 320 is disposed with the light polarizing part 310.

In this embodiment, the light diffusing part 320 is integrally formed with the light polarizing part 310. The light diffusing part 320 enhances uniformity of luminance of the light that passes through the light polarizing part 310 and produces the second light which has both higher luminance and uniformity of luminance than the first light, thereby improving the display quality of images displayed at the display section 200. The light diffusing part 320 may include polycarbonate (PC) or polymethylmetacrylate (PMMA). In the present embodiment, the light diffusing part 320 includes PC. The light diffusing part 320 has a thickness of about 0.8 mm to about 1.0 mm in order to prevent the light polarizing part 310 and the light diffusing part 320 from sagging.

The light diffusing part 320 may include a plurality of beads 322 having a spherical shape in order to enhance a light diffusing function of the light diffusing part 320. The beads 322 may be disposed in the light diffusing part 320. Alternatively, 25 the beads 322 may be disposed on a surface of the light diffusing part 320. The beads 322 have a different index of refraction from that of the light diffusing part 320.

The light diffusing part 320 may also include a plurality of vesicles (not shown) in order to improve the light diffusing function of the light diffusing part 320. Light that enters the light diffusing part 320 is diffused by the vesicles to provide light having enhanced uniformity. In another embodiment, the light diffusing part 320 may include both the beads 322 and the vesicles.

According to the present embodiment, the light polarizing part 310 and the light diffusing part 320 are integrally formed through an adhesive or a coating method. When the optical member 300 having the light diffusing part 320 integrally formed with the light polarizing part 310 is disposed between the light generating section 100 and the display section 200, luminance and uniformity of luminance of light provided to the display section 200 are increased. Additionally, due to size characteristics of the optical member 300, a size, a volume, a weight, etc. of a display device employing the optical member are reduced relative to alternative methods of increasing luminance and uniformity of luminance of light.

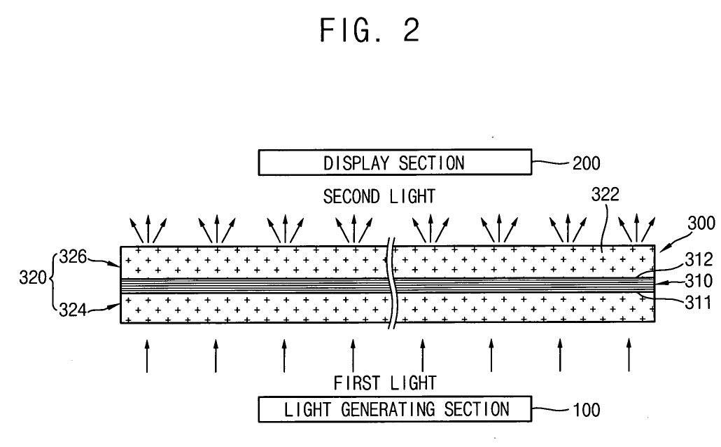

FIG. 2 is a schematic diagram of a cross-sectional view illustrating an optical member according to a second exemplary embodiment of the present invention. The optical member in FIG. 2 is same as in the embodiment in FIG. 1 except for a light diffusing part. Thus, the same reference numerals will be used in FIG. 2 to refer to the same or like parts as those described in the embodiment of FIG. 1 and any further explanation will be omitted.

Referring to FIG. 2, the light diffusing part 320 includes a first light diffusing layer 324 and a second light diffusing layer 326. The light polarizing part 310 is interposed between the first and second light diffusing layers 324 and 326. The first light diffusing layer 324 is disposed on a first face 311 of the light polarizing part 310 and integrally formed with the light polarizing part 310, and the second light diffusing layer 326 is disposed on a second face 312 of the light polarizing part 310 and integrally formed with the light polarizing part 310.

The first light generated from the light generating section 100 is diffused by the first light diffusing layer 324 and enters the light polarizing part 310. Light that exits the light polarizing part 310 is diffused again by the second light diffusing layer 326 to produce the second light having a higher uniformity of luminance than that of the embodiment in FIG. 1. When the uniformity of the luminance of the second light is enhanced, uniformity of luminance of images displayed through the display section 200 is also enhanced to improve display quality.

The first and second light diffusing layers 324 and 326 may include polycarbonate (PC) or polymethylmetacrylate (PMMA). In the present embodiment, the first and second light diffusing layers 324 and 326 include PC. A thickness of each of the first and second light diffusing layers 324 and 326 is in a range of about 0.8 mm to about 1.0 mm in order to prevent the light polarizing part 310, and the first and second light diffusing layers 324 and 326 from sagging.

At least one of the first and second light diffusing layers 324 and 326 may include a plurality of beads 322 having a spherical shape in order to enhance the light diffusing function of the first and second light diffusing layers 324 and 326. The beads 322 may be disposed in the first and second light diffusing layers 324 and 326. Alternatively, the beads 322 may be disposed on a surface of the first and second light diffusing layers 324 and 326. The beads 322 have a different index of refraction from that of the first and second light diffusing layers 324 and 326.

At least one of the first and second light diffusing layers 324 and 326 may include a plurality of vesicles (not shown) in order to improve the light diffusing function. Light that enters the light diffusing part 320 is diffused by the vesicles to provide light having enhanced uniformity.

One of the first and second light diffusing layers 324 and 326 may include the beads 322 and the other may include the vesicles. Alternatively, both of the first and second light diffusing layers 324 and 326 may include both the beads 322 and the vesicles.

According to the present embodiment, the light diffusing part 320 includes the first and second light polarizing layers 324 and 326 disposed on the first and second faces of the light polarizing part 310 in order to diffuse light two times. Therefore, the uniformity of luminance of the second light provided to the display section 200 is enhanced and display quality of images is enhanced.

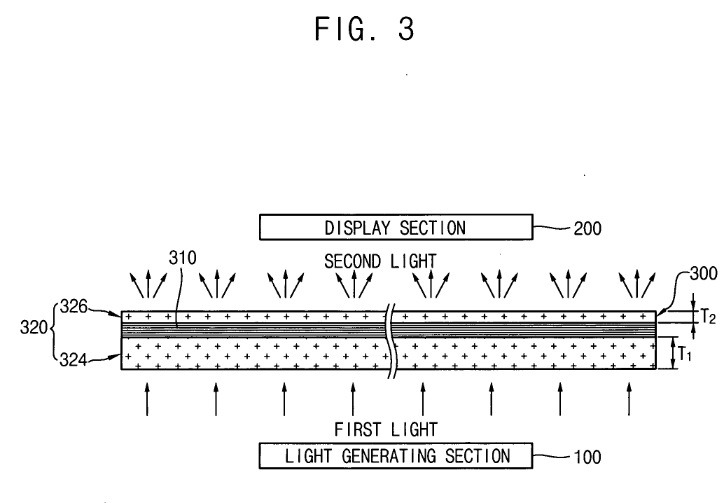

FIG. 3 is a schematic diagram of a cross-sectional view illustrating an optical member according to a third exemplary embodiment of the present invention. The optical member in FIG. 3 is same as in the embodiment in FIG. 2 except for a light diffusing part. Thus, the same reference numerals will be used in FIG. 3 to refer to the same or like parts as those described in the embodiment of FIG. 2 and any further explanation will be omitted.

Referring to FIG. 3, the first light-polarizing layer 324 of the light polarizing part 320 has a first thickness T1, and the second light-polarizing layer 326 of the light polarizing part 320 has a second thickness T2. The first thickness T1 is greater than the second thickness T2, and each of the first thickness T1 and the second thickness T2 is in the range of about 0.8 mm to about 1.0 mm. Since the first thickness T1 is greater than the second thickness T2, the first light diffusing layer 324 has a first haze value, and the second light diffusing layer 326 has a second haze value that is smaller than the first haze value.

The first and second haze values are expressed as the following Expression 1.
Haze value=(DT/T)×100, Expression 1
wherein ‘T’ represents an amount of light that enters the first light diffusing layer 324 or the second light diffusing layer 326, and ‘DT’ represents an amount of light that is diffusively transmitted by the first light diffusing layer 324 or the second light diffusing layer 326. Therefore, a diffusing layer having a high haze value has a high diffusing characteristic.

In the present embodiment, the first light diffusing layer 324 has a higher haze value than that of the second light diffusing layer 326. When a haze value of the second light diffusing layer 326 is higher than that of the first light diffusing layer 324, an amount of light loss increases.

According to the present embodiment, the haze value of the first light diffusing layer 324 and the haze value of the second light diffusing layer 326 are adjusted such that the haze value of the first light diffusing layer 324 is higher than that of the second light diffusing layer 326 to reduce the amount of light loss and thereby enhance the uniformity of luminance of the second light.

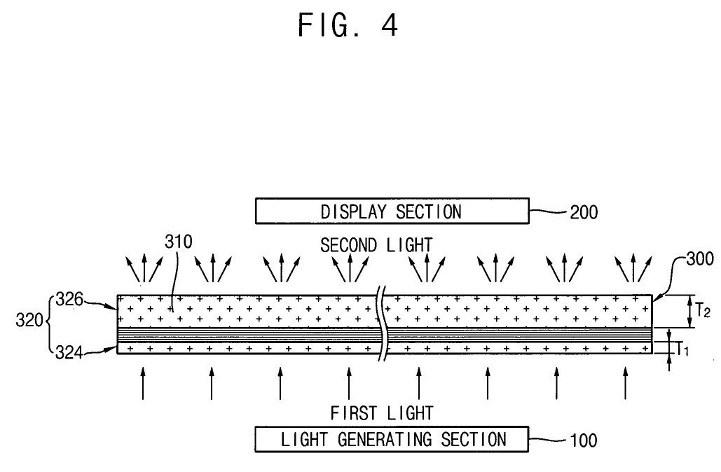

FIG. 4 is a schematic diagram of a cross-sectional view illustrating an optical member according to a fourth exemplary embodiment of the present invention.

Referring to FIG. 4, the first light-diffusing layer 324 has a first thickness T1, and the second light-diffusing layer 326 has a second thickness T2 that may be greater than the first thickness T1. Each of the first thickness T1 and the second thickness T2 is in the range of about 0.8 mm to about 1.0 mm.

In the present embodiment, an amount of beads or vesicles that are disposed in the first and second light diffusing layers 324 and 326 is adjusted such that the amount beads or vesicles that are disposed in the first light diffusing layer 324 is larger than the amount beads or vesicles that are disposed in the second light diffusing layer 326. Therefore, the first light diffusing layer 324 has a higher haze value than that of the second light diffusing layer 326.

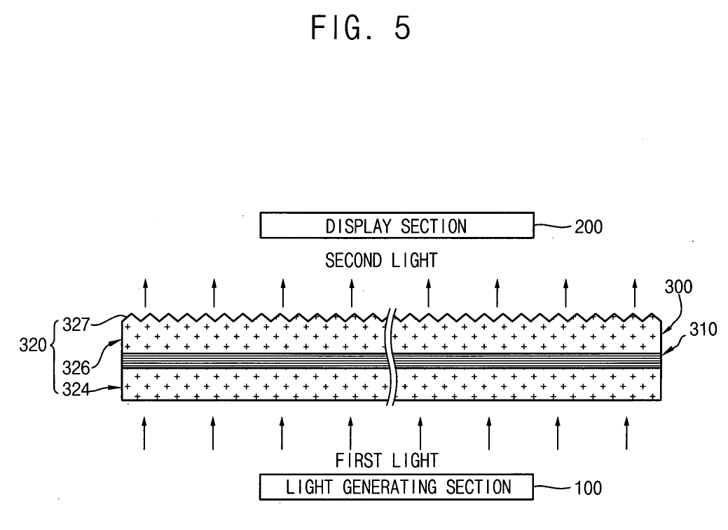

FIG. 5 is a schematic diagram of a cross-sectional view illustrating an optical member according to a fifth exemplary embodiment of the present invention. The optical member in FIG. 5 is same as in the embodiment of FIG. 2 except for a light diffusing part. Thus, the same reference numerals will be used in FIG. 5 to refer to the same or like parts as those described in the embodiment of FIG. 2 and any further explanation will be omitted.

Light that exits the second light diffusing layer 326 of the embodiment in FIG. 2 may be diffused such that a portion of the second light is slanted with respect to a surface of the second light diffusing layer 326. The portion of the second light which is slanted with respect to the surface of the second light diffusing layer 326, lowers luminance of light received at the display section and thereby lowers display quality of images displayed at the display section 200. In order to enhance the luminance of images displayed at the display section 200, the surface of the second light diffusing layer 326 is transformed.

Referring to FIG. 5, the surface of the second light diffusing layer 326 that faces the display section 200 includes patterns (or a light condensing part) 327. A cross-section of the patterns 327 has a saw-tooth shape. When the second light diffusing layer 326 includes the patterns 327, the second light exits the second light diffusing layer 326 in a direction substantially normal to a surface of the light polarizing part 310. Therefore, luminance of the second light is enhanced and display quality of images displayed at the display section 200 is enhanced.

A vertical angle between opposing faces defining the patterns 327 is in a range of about 90 degrees to about 120 degrees. When the vertical angle is smaller than 90 degrees, light may be reflected by the patterns 327 toward the light polarizing part 310 to lower luminance of the second light and decrease display quality of images displayed at the display section 200. In the present embodiment the patterns 327 are integrally formed with the second light diffusing layer 326.

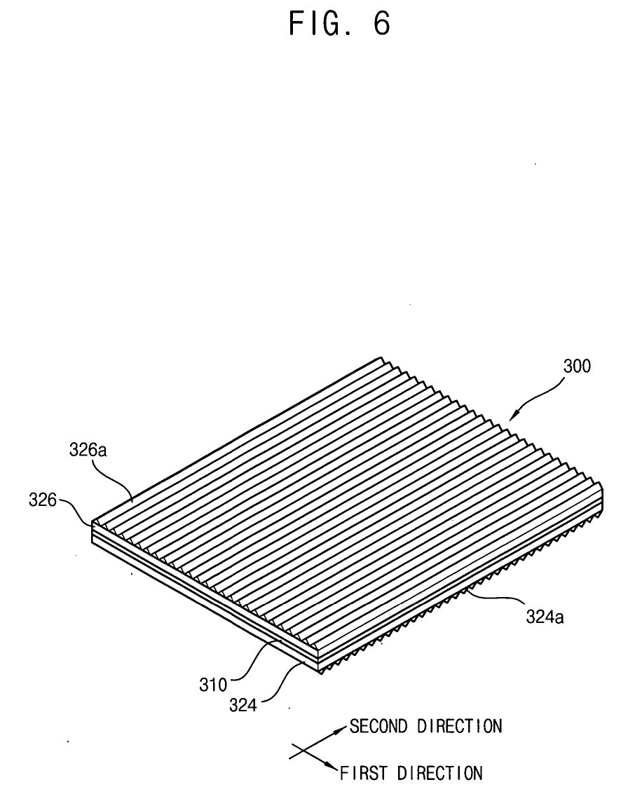

FIG. 6 is a perspective view illustrating an optical member according to a sixth exemplary embodiment of the present invention. The optical member in FIG. 6 is same as in the embodiment in FIG. 5 except for patterns. Thus, the same reference numerals will be used in FIG. 6 to refer to the same or like parts as those described in the embodiment of FIG. 5 and any further explanation will be omitted.

Referring to FIG. 6, the first light diffusing layer 324 includes first patterns 324a, and the second light diffusing layer 326 includes second patterns 326a. The first and second patterns 324a and 326a are disposed at bottom and top exterior surfaces of the first and second light diffusing layers 324 and 326, respectively. A cross-section of the first patterns 324a has a saw-tooth shape, and the first patterns 324a are extended along a first direction. A cross-section of the second patterns 326a also has a saw-tooth shape, and the second patterns 326a are extended along a second direction that is substantially perpendicular to the first direction.

Light that enters the first light diffusing layer 324 through the first patterns 324a is diffused by the first patterns 324a. Light that exits the second light diffusing layer 326 through the second patterns 326a is condensed to be normal with respect to the surface of the light polarizing part 310. Therefore, luminance and uniformity of the luminance of the second light are enhanced thereby enhancing display quality of images displayed at the display section 200.

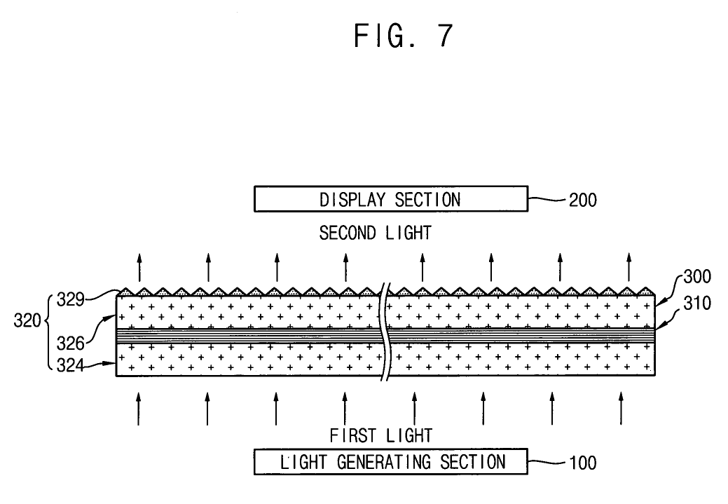

FIG. 7 is a schematic diagram of a cross-sectional view illustrating an optical member according to a seventh exemplary embodiment of the present invention. The optical member in FIG. 7 is same as in the embodiment in FIG. 2 except for a pattern layer. Thus, the same reference numerals will be used in FIG. 7 to refer to the same or like parts as those described in the embodiment of FIG. 2 and any further explanation will be omitted.

Referring to FIG. 7, a pattern layer 329 is disposed at a surface of the second light diffusing layer 326. The pattern layer 329 is attached on the second light diffusing layer 326 through, for example, an adhesive. A cross-section of the pattern layer 329 has a saw-tooth shape. In other words, the pattern layer includes a plurality of triangular prisms disposed substantially parallel to each other.

When the pattern layer 329 is formed on the second light diffusing layer 326, the second light exits the pattern layer 329 in a direction substantially normal with respect to the surface of the light polarizing part 310. Therefore, luminance of the second light is enhanced and display quality of images displayed at the display section 200 is enhanced.

The vertical angle between opposing faces defining the pattern layer 329 is in the range of about 90 degrees to about 120 degrees. When the vertical angle is smaller than 90 degrees, light may be reflected by the pattern layer 329 toward the light polarizing part 310 to lower luminance the second light decrease display quality of images displayed at the display section 200.

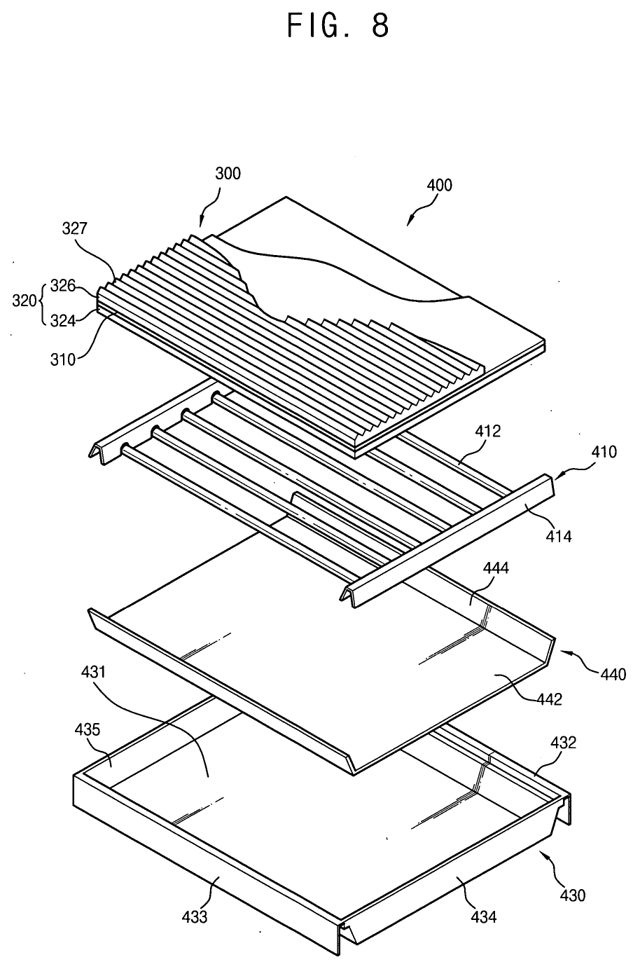

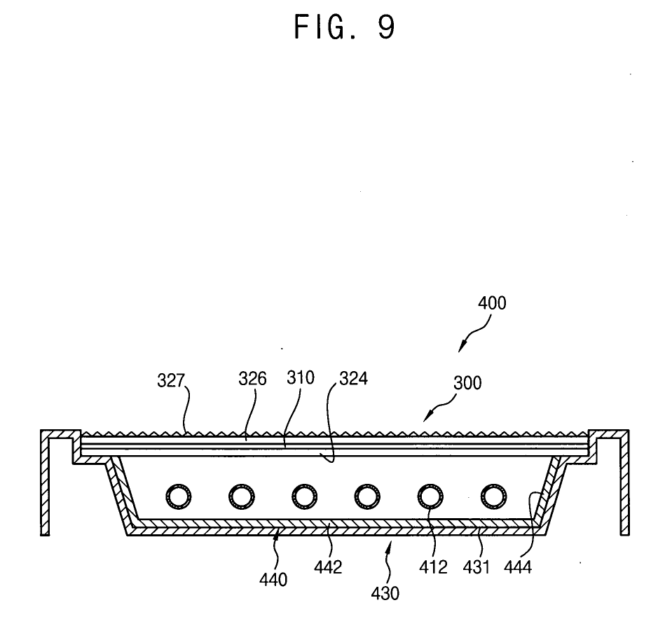

FIG. 8 is an exploded perspective view illustrating a backlight assembly having the optical member of FIG. 7 according to an exemplary embodiment of the present invention, and FIG. 9 is a schematic diagram of a cross-section view illustrating the backlight assembly in FIG. 8.

Referring to FIGS. 8 and 9, a backlight assembly 400 includes a lamp assembly 410 for generating light, an optical member 300 for enhancing optical characteristics of the light generated by the lamp assembly 410, a receiving container 430 for receiving the lamp assembly 410 and the optical member 300, and a light reflecting plate 440 that is disposed between the receiving container 430 and the lamp assembly 410.

The lamp assembly 410 includes a plurality of lamps 412 and a lamp-fixing member 414. Each of the lamps 412 generates light. The lamp-fixing member 414 is disposed at an end portion of the lamps 412 and fixes the lamps 412. The lamp-fixing member 414 covers a voltage applying part (not shown) through which a voltage for driving the lamps 412 is applied to the lamps 412.

The receiving container 430 includes a bottom plate 431 and four sidewalls 432, 433, 434 and 435. The sidewalls 432, 433, 434 and 435 are extended upward from edge portions of the bottom plate 431. The receiving container 430 receives the lamp assembly 410 and the optical member 300. The lamp assembly 410 is disposed on the bottom plate 431 of the receiving container 430, and the optical member 300 is disposed over the lamp assembly 410.

The optical member 300 polarizes, diffuses and condenses light generated from the lamps 412 of the lamp assembly 410. The optical member 300 includes the light polarizing part 310, the light diffusing part 320 and a light condensing part 327.

The light polarizing part 310 polarizes light generated from the lamps 412, so that light that passes through the polarizing part 310 is polarized. The polarizing part 310 has a film-like shape. The light polarizing part 310 may employ, for example, the DBEF.

The light diffusing part 320 includes a first light diffusing layer 324 and a second light diffusing layer 326. The first light diffusing layer 324 is disposed on a bottom face of the light polarizing part 310 to face the bottom plate 431 of the receiving container 430. The second light-diffusing layer 326 is disposed on a top face of the light polarizing part 310.

The first and second light diffusing layers 324 and 326 include polycarbonate (PC) or polymethylmetacrylate (PMMA). Alternatively, the first and second light diffusing layers 324 and 326 may include both PC and PMMA. Each of the first and second light diffusing layers 324 and 326 has a thickness in the range of about 0.8 mm to about 1.0 mm.

The first and second light diffusing layers 324 and 326 may include a plurality of beads having a spherical shape in order to enhance the light diffusing function of the light diffusing part 320. The beads may be disposed in the first and second light diffusing layers 324 and 326. Alternatively, the beads may be disposed on a surface of the first and second light diffusing layers 324 and 326. The beads have a different index of refraction from that of the first and second light diffusing layers 324 and 326.

The first and second light diffusing layers 324 and 326 may include a plurality of vesicles (not shown) in order to improve the light diffusing function of the light diffusing part 320. Light that enters the first and second light diffusing layers 324 and 326 is diffused by the vesicles to have enhanced uniformity of luminance. The first and second light diffusing layers 324 and 326 may include both the beads 322 and the vesicles.

A cross-section of the light condensing part 327 has a saw-tooth shape. The saw-tooth shape is extended along a longitudinal direction substantially parallel to the longitudinal direction of the lamps 412. The light condensing part 327 adjusts light paths of light that exits the optical member 300 to enhance luminance of the light.

The light reflecting plate 440 is disposed between the bottom plate 431 of the receiving container 430 and the lamp assembly 410 to reflect light toward the optical member 300, thereby increasing an amount of light advancing toward the optical member 300. The light reflecting plate 440 includes a bottom reflector 442 and a side reflector 444. In the present embodiment, the optical member 300 may employ one of the previous embodiments.

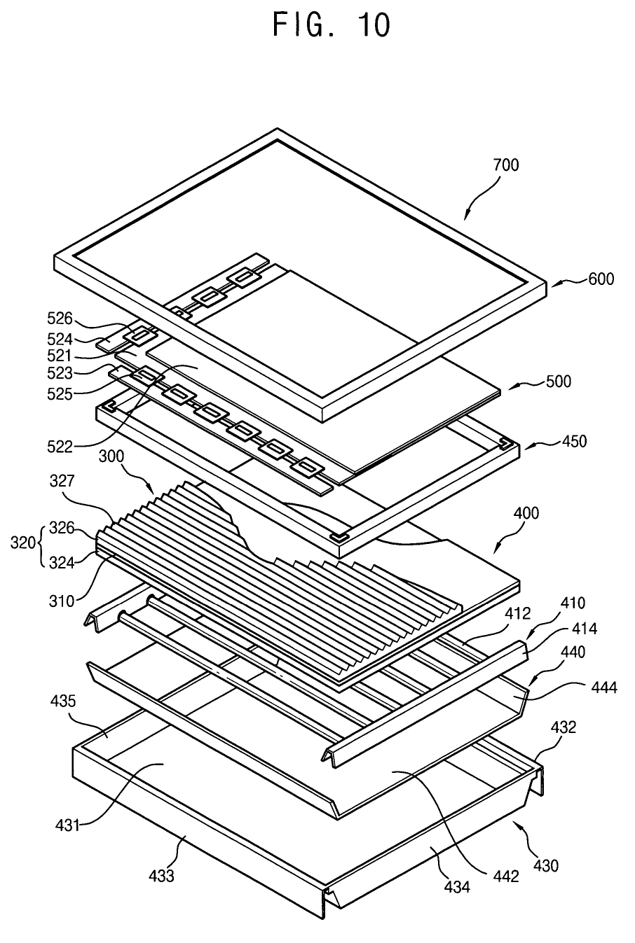

FIG. 10 is an exploded perspective view illustrating a display device according to an exemplary embodiment of the present invention.

Referring to FIG. 10, a display device 700 according to the present embodiment includes a backlight assembly 400, a display panel 500 and a top chassis 600.

The backlight assembly 400 includes the lamp assembly 410 having the plurality of lamps 412, the optical member 300 enhancing optical characteristics of the light generated from the plurality of lamps 412, the receiving container 430 receiving the lamp assembly 410 and the optical member 300, and the light reflecting plate 440 that reflects light generated from the lamp 412 toward the optical member 300.

The display apparatus 700 may further include a middle chassis 450 that fixes the optical member 300 to the receiving container 430 and supports the display panel 500. The display panel 500 includes a thin film transistor (TFT) substrate 521, a color filter substrate 522, a data printed circuit board (PCB) 523 and a gate PCB 524. The data PCB 523 and the gate PCB 524 are combined with the display panel 500 through a data tape carrier package (TCP) 525 and a gate TCP 526, respectively. The TFT substrate 521 faces the color filter substrate 522. Liquid crystal is disposed between the TFT substrate 521 and the color filter substrate 522. When electric fields are applied to the liquid crystal, an arrangement of liquid crystal molecules is changed to adjust optical transmittance, so that images are displayed. The top chassis 600 fixes the display panel 500 to the receiving container 430 and protects the display panel 500. In the present embodiment, the optical member 300 may employ one of the previous embodiments.

Having described the exemplary embodiments of the present invention and its advantages, it is noted that various changes, substitutions and alterations can be made herein without departing from the spirit and scope of the invention as defined by appended claims.

1. An optical member disposed between a light generating section that generates light and a display section that displays images by using the light generated by the light generating section, comprising:
a light polarizing part configured to polarize the light generated by the light generating section; and
a light diffusing part integrally formed with the light polarizing part, the light diffusing part diffusing the light generated by the light generating section to enhance uniformity of luminance of the light.

2. The optical member of claim 1, wherein the light diffusing part comprises polycarbonate.

3. The optical member of claim 1, wherein the light diffusing part comprises polymethylmetacrylate.

4. The optical member of claim 1, wherein the light diffusing part comprises beads that diffuse the light.

5. The optical member of claim 4, wherein the beads are disposed at one of:
selected portions within the light diffusing part; and
a surface of the light diffusing part.

6. The optical member of claim 1, wherein the light diffusing part has a thickness of about 0.8 mm to about 1.0 mm.

7. The optical member of claim 1, wherein the light diffusing part has patterns formed on a surface of the light diffusing part to condense the light.

8. The optical member of claim 7, wherein a cross-section of the patterns has a saw-tooth shape and a vertical angle between opposing faces defining the patterns is in a range of about 90 degrees to about 120 degrees.

9. The optical member of claim 1, wherein the light diffusing part comprises:
a first light diffusing layer disposed at a bottom face of the light polarizing part to face the light generating section; and
a second light diffusing layer disposed at a top face of the light polarizing part to face the display section, the first and second diffusing layers have first patterns and second patterns, respectively, a cross-section of which each has a saw-tooth shape.

10. The optical member of claim 9, wherein a longitudinal direction of the first patterns is substantially perpendicular to a longitudinal direction of the second patterns.

11. The optical member of claim 1, further comprising a pattern layer disposed on the light diffusing part and having a plurality of triangular prisms arranged substantially parallel to each other.

12. An optical member disposed between a light generating section that generates light and a display section that displays images by using the light generated by the light generating section, comprising:
a light polarizing part configured to polarize the light generated by the light generating section;
a first light diffusing layer disposed at a bottom face of the light polarizing part to face the light generating section; and
a second light diffusing layer disposed at a top face of the light polarizing part to face the display section.

13. The optical member of claim 12, wherein the first light diffusing layer has a first haze value, and the second light diffusing layer has a second haze value that is smaller than the first haze value.

14. The optical member of claim 12, wherein the first light diffusing layer has a first thickness, the second light diffusing layer has a second thickness that is smaller than the first thickness.

15. The optical member of claim 14, wherein each of the first thickness and the second thickness is in a range of about 0.8 mm to about 1.0 mm.

16. The optical member of claim 12, wherein the first light diffusing layer comprises a first amount of beads, and the second light diffusing layer comprises a second amount of beads that is less than the first amount.

17. A backlight assembly comprising:
a plurality of lamps that generate light; and
an optical member disposed over the plurality of lamps, the optical member comprising:
a light polarizing part that polarizes the light generated by the plurality of lamps; and
a light diffusing part integrally formed with the light polarizing part, the light diffusing part diffusing the light to enhance uniformity of luminance of the light.

18. The backlight assembly of claim 17, wherein the light diffusing part comprises a first light polarizing layer disposed on a bottom face of the light polarizing part to face the plurality of lamps, and a second light polarizing layer disposed on a top face of the light polarizing part to face a display section.

19. The backlight assembly of claim 17, wherein the light diffusing part has patterns formed on a surface of the light diffusing part to condense the light.

20. The backlight assembly of claim 17, wherein the light diffusing part comprises:
a first light diffusing layer disposed on a bottom face of the light polarizing part to face the plurality of lamps; and
a second light diffusing layer disposed on a top face of the light polarizing part, the first and second diffusing layers have first patterns and second patterns, respectively, a cross-section of which each has a saw-tooth shape.

21. The backlight assembly of claim 20, wherein a longitudinal direction of the first patterns is substantially perpendicular to that of the second patterns.

22. The backlight assembly of claim 17, wherein the light diffusing part comprises polycarbonate.

23. The backlight assembly of claim 17, wherein the light diffusing part comprises polymethylmetacrylate.

24. The backlight assembly of claim 17, wherein the light diffusing part comprises beads that diffuse the light.

25. A display apparatus comprising:
a plurality of lamps that generate light;
a display panel that displays images using the light generated by the plurality of lamps; and
an optical member disposed between the plurality of lamps and the display panel, the optical member comprising:
a light polarizing part configured to polarize the light generated by the plurality of lamps; and
a light diffusing part integrally formed with the light polarizing part, the light diffusing part diffusing the light to enhance uniformity of luminance of the light.

26. The display apparatus of claim 25, wherein the light diffusing part comprises:
a first light diffusing layer disposed at a bottom face of the light polarizing part to face the plurality of lamps; and
a second light diffusing layer disposed on a top face of the light polarizing part, the first and second diffusing layers have first patterns and second patterns, respectively, a cross-section of which each has a saw-tooth shape.

27. The backlight assembly of claim 26, wherein a longitudinal direction of the first patterns is substantially perpendicular to a longitudinal direction of the second patterns.
